(19) United States
(12) Patent Application Publication
(10) Pub. No.: US 2016/0065780 A1
(43) Pub. Date: Mar. 3, 2016

(54) IMAGE FORMING APPARATUS FOR PRINTING SHEETS SCANNED FROM A BOOK

(71) Applicants: KABUSHIKI KAISHA TOSHIBA, Tokyo (JP); TOSHIBA TEC KABUSHIKI KAISHA, Tokyo (JP)

(72) Inventors: Tomokazu Sakabe, Mishima Shizuoka (JP); Saravanacoumar Dourecannou, T.R. Pattinam (FR); Anirudh Mysore Anand, Bangalore (IN)

(21) Appl. No.: 14/469,430

(22) Filed: Aug. 26, 2014

(51) Int. Cl. H04N 1/23; H04N 1/393; B41J 2/01

(52) U.S. Cl. CPC H04N 1/2323; B41J 2/01; H04N 1/393

(57) ABSTRACT

An image forming apparatus includes a printer, an image reader configured to scan and generate image data of a first page and a second page of an opened book, and a processor. The processor is configure to set a magnification so that an image size of the image data generated by the image reader becomes a size of a sheet among a plurality of sheets to be printed, correlate the image data of each page with portions of the plurality of sheets to be printed, respectively, and control the printer to print images corresponding to the image data on the respective correlated portions of the plurality of sheets so that the images corresponding to the image data are arranged on the portions of the plurality of sheets in a scanned order when the plurality of sheets are bound in a bookbinding state.

### FIELD

Embodiments described herein relate generally to an image forming apparatus for printing sheets scanned from a book.

### BACKGROUND

An image forming apparatus such as a Multi Function Peripheral (MFP) has functions of copying, scanning, and the like.

When each page of a book is scanned and bound using an image forming apparatus, there is a possibility that the order of pages after binding becomes different from that of the original book.

### DESCRIPTION OF THE DRAWINGS

FIG. 1 is a perspective view of an image forming apparatus according to an embodiment.

FIG. 2 is a diagram which illustrates an example configuration of the image forming apparatus according to the embodiment.

FIG. 3 illustrates an example data table which is stored in a storage unit.

FIG. 4 illustrates an example of a printing position of each image on a sheet.

FIG. 5 illustrates an example of printing order in each sheet.

FIG. 6 illustrates an example sequence of operations for setting functions of the image forming apparatus according to the embodiment.

FIG. 7 illustrates an example sequence of operations for scanning processing in the image forming apparatus according to the embodiment.

FIG. 8 illustrates an example sequence of operations for printing processing in the image forming apparatus according to the embodiment.

### DETAILED DESCRIPTION

In general, according to one embodiment, there is provided an image forming apparatus includes a printer, an image reader configured to scan and generate image data of a first page and a second page of an opened book, and a processor. The processor is configure to set a magnification so that an image size of the image data generated by the image reader becomes a size of a sheet among a plurality of sheets to be printed, correlate the image data of each page with portions of the plurality of sheets to be printed, respectively, and control the printer to print images corresponding to the image data on the respective correlated portions of the plurality of sheets so that the images corresponding to the image data are arranged on the portions of the plurality of sheets in a scanned order when the plurality of sheets are bound in a bookbinding state.

Hereinafter, an image forming apparatus according to the embodiment will be described with reference to drawings.

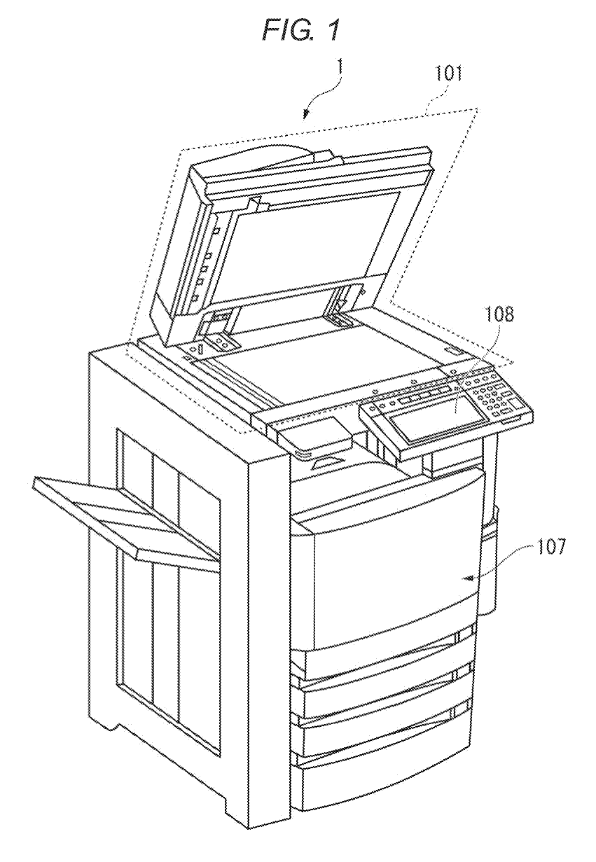

FIG. 1 is a perspective view of an example image forming apparatus 1 according to the embodiment. The image forming apparatus 1 generates image data (digital data) by reading an image. For example, the image forming apparatus 1 is a multifunction printer.

The image forming apparatus 1 includes an image reading unit 101, a printing unit 107, and an output unit 108. The image forming apparatus 1 may be, for example, an ink jet image forming apparatus or an image forming apparatus which fixes a toner image.

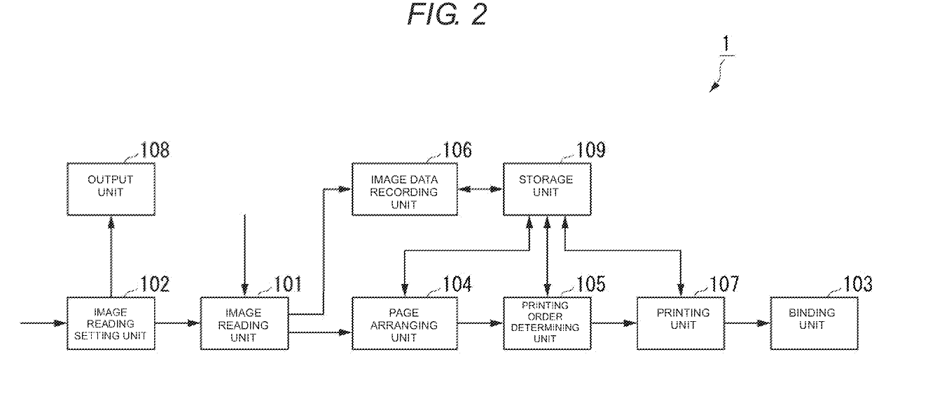

FIG. 2 is a diagram which illustrates an example configuration of the image forming apparatus 1, according to the embodiment. The image forming apparatus 1 includes the image reading unit 101, an image reading setting unit 102, a binding unit 103, a page arranging unit 104, a printing order determining unit 105, an image data recording unit 106, the printing unit 107, the output unit 108, and a storage unit 109. In one embodiment, the various units 102-106 are implemented as software running on a processor. The image reading unit 101 scans a first page and a second page of an opened book. The first page is a page on one side of the opened book. The second page is a page on the other side which is different from the first page of the opened book. The image reading unit 101 generates a scanned image from the scanned pages. The image reading unit 101 is an image reader such as, for example, a scanner, a CCD device, and the like.

The image reading setting unit 102 changes a magnification so that a size of the scanned image becomes a sheet size.

The binding unit 103 binds a plurality of sheets in a bookbinding state.

The page arranging unit 104 causes image data corresponding to each page to be correlated with portions of a plurality of sheets that are to be printed, so that the image data in each page is in scanned order.

The printing order determining unit 105 determines a printing order of duplex printing of the plurality of sheets that are to be printed, based on the correlation from the page arranging unit 104.

The image data recording unit 106 records the image data for each page which is scanned in the storage unit 109 and also causes the stored image data to be correlated with a page number.

The printing unit 107 prints images on a plurality of sheets based on the printing order—which is determined by the printing order determining unit 105—and the image data.

The output unit 108 provides a user with various information. For example, the output unit 108 may be a display with a function of a touch panel, a speaker which outputs sound, or the like.

The storage unit 109 is a storage unit which stores various data necessary for processing in the image forming apparatus 1. For example, the storage unit 109 stores a data table T1.

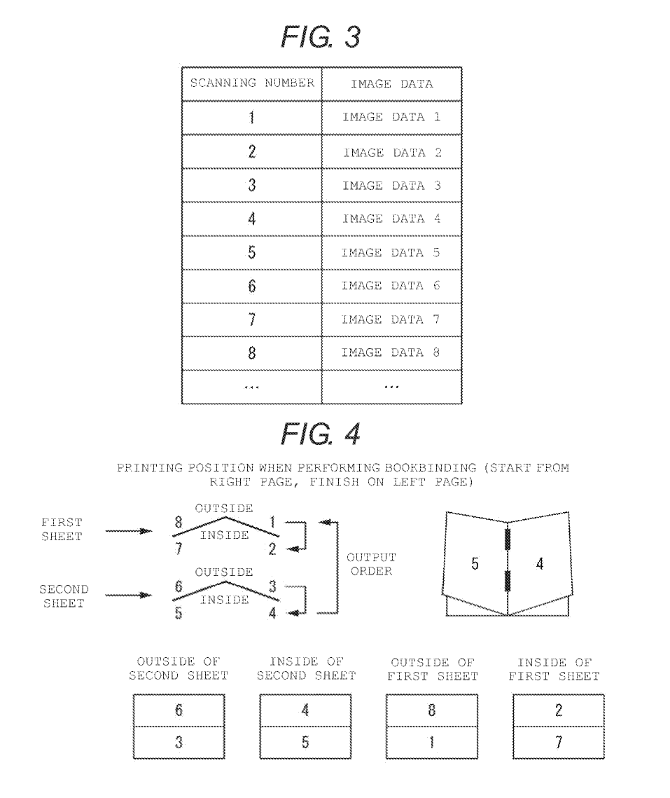

FIG. 3 illustrates an example of the data table T1 which is stored in the storage unit 109.

As illustrated in FIG. 3, the data table T1 is a table which denotes a correlation between a scanning number and image data of a scanned image. The scanning number denotes a scanned order of each a plurality of pages of a book using the image reading unit 101.

FIG. 4 illustrates an example of a printing position of each image on a sheet.

Here, for ease of descriptions, the right side in FIG. 4 is referred to as a right page. In addition, the left side in FIG. 4 is referred to as a left page. In addition, the upper side in FIG. 4 is referred to as the outside. Also, the lower side in FIG. 4 is referred to as the inside. As illustrated in FIG. 4, when there are eight image data items, the page arranging unit 104 causes the eight image data items to be correlated with 8÷4=2 sheets. The page arranging unit 104 causes the first image data to be correlated with the right page on the outside of the first sheet. The page arranging unit 104 causes the second image data to be correlated with the right page on the inside of the first sheet. The page arranging unit 104 causes the third image data to be correlated with the right page on the outside of the second sheet. The page arranging unit 104 causes the fourth image data to be correlated with the right page on the inside of the second sheet. The page arranging unit 104 causes the fifth image data to be correlated with the left page on the inside of the second sheet. The page arranging unit 104 causes the sixth image data to be correlated with the left page on the outside of the second sheet. The page arranging unit 104 causes the seventh image data to be correlated with the left page on the inside of the first sheet. The page arranging unit 104 causes the eighth image data to be correlated with the left page on the outside of the first sheet.

In addition, when the number of image data items is arbitrarily large, the page order may be expressed generally as follows. The page arranging unit 104 regards one of four scanned pages as the first page. In addition, a half of a single scanned surface of a sheet becomes one page. The page arranging unit 104 sets the rear surface of the first scanned page to be the second page. The page arranging unit 104 sets a scanned page neighboring the second scanned page to be the third page. The page arranging unit 104 sets the rear surface of the third scanned page to be the fourth page.

The page arranging unit 104 adds zero to three pages of dummy image data to the image data so that the total pages become 4N.

The page arranging unit 104 correlates image data items N sheets. The first page of the (M+1)th sheet faces the second page of the Mth sheet. The fourth page of the (M+1)th sheet faces the third page of the Mth sheet. In addition, N is an integer which is equal to or greater than 2. M is an integer of 1 to N−1. The page arranging unit 104 correlates the (2M−1)th image data with the first page of the Mth sheet. The page arranging unit 104 correlates the (2M)th image data with the second page of the Mth sheet. The page arranging unit 104 correlates the (4N−2M+1)th image data with the third page of the Mth sheet. The page arranging unit 104 correlates the (4N−2M+2)th image data with the fourth page of the Mth sheet.

FIG. 5 illustrates an example of printing order in each sheet. As illustrated in FIG. 5, if the image forming apparatus 1 allows a user to input two sheets in advance onto a duplex transport path, the printing order determining unit 105 determines that the outside of the second sheet is printed first as the rear surface. The printing order determining unit 105 determines that the outside of the first sheet is printed second as the rear surface. The printing order determining unit 105 determines that the inside of the second sheet is printed third as the front surface. The printing order determining unit 105 determines that the inside of the first sheet is printed fourth as the front surface.

FIG. illustrates an example sequence of operations for setting functions of the image forming apparatus 1, according to the embodiment.

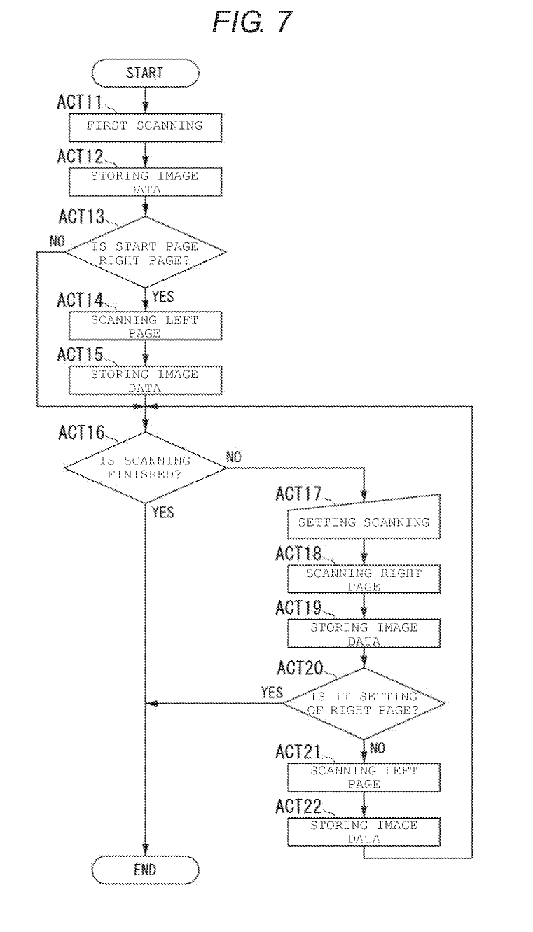

FIG. 7 illustrates an example sequence of operations for scanning processing in the image forming apparatus 1, according to the embodiment.

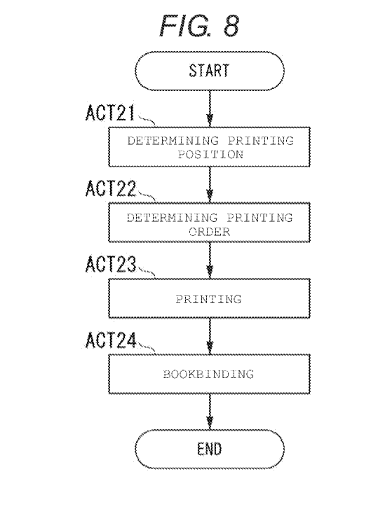

FIG. 8 illustrates an example sequence of operations for printing processing of the image forming apparatus 1, according to the embodiment.

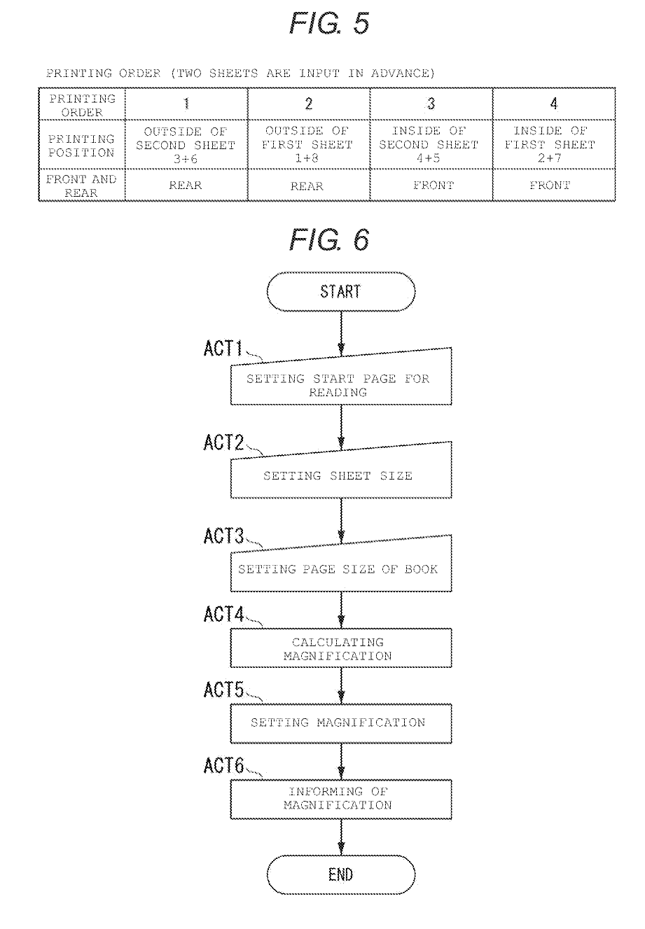

Operations of the image forming apparatus 1 according to the embodiment will be described using FIGS. 6 to 8.

Here, the first page will be described as the right page. In addition, the second page will be described as the left page.

First, operations for setting functions of the image forming apparatus 1 according to the embodiment which is illustrated in FIG. 6 will be described. The settings of the image forming apparatus 1 are for scanning an opened book.

A user determines whether the first page for reading to be started is to be the right page (first page) or the left page (second page) of a book from a user interface (control panel, or the like) of the image forming apparatus 1. The image reading setting unit 102 outputs page information to the image reading unit 101 according to setting by a user. The page information denotes whether the first page for reading to be started is the right page (first page) or the left page (second page) of the book.

The image reading unit 101 receives the page information from the image reading setting unit 102. The image reading unit 101 sets the first page for reading to be the right page or the left page based on the received page information (ACT 1; setting page for reading to be started).

The user sets a size of a sheet to be printed. The image reading setting unit 102 outputs sheet size information to the image reading unit 101 according to setting by the user. The sheet size information denotes the size of the sheet to be printed.

The image reading unit 101 receives the sheet size information from the image reading setting unit 102. The image reading unit 101 sets the size of the sheet to be printed based on the received sheet size information (ACT 2; setting sheet size).

The user sets a page size of a book. The image reading setting unit 102 outputs page size information to the image reading unit 101 according to the setting by the user. The page size information denotes the page size of the book.

The image reading unit 101 receives the page size information from the image reading setting unit 102. The image reading unit 101 sets the page size of the book according to the page size input information (ACT 3; setting page size of book).

The image reading setting unit 102 calculates a magnification, based on the sheet size and the page size of the book to be printed, so that the page size matches the sheet size (ACT 4; calculating magnification). For example, when the sheet size is B4, and the page size of the book is B5, the image reading setting unit 102 calculates the magnification as 100%. The image reading setting unit 102 outputs the calculated magnification to the image reading unit 101 (ACT 5; setting magnification). The image reading setting unit 102 informs the user of the calculated magnification through the output unit 108 (ACT 6; informing of magnification).

Operations for scanning processing in the image forming apparatus 1, which is illustrated in FIG. 7, is now described.

The user sets the first page of the book in the image reading unit 101 after the function setting of the image forming apparatus 1. The user presses a scanning execution button of the image forming apparatus 1.

The image reading unit 101 scans the first page of the book in response to the scanning execution button being pressed by the user (ACT 11; first scanning). The first page of the book is set by the function setting of the image forming apparatus 1. For example, when the first page of the book is set to the right page during function setting of the image forming apparatus 1, the image reading unit 101 scans the right page of the book in response to the pressing of the scanning execution button being pressed by the user.

The image reading unit 101 outputs the scanned image data of the first page of the book to the image data recording unit 106.

The image data recording unit 106 receives the image data of the first page of the book from the image reading unit 101. The image data recording unit 106 correlates a scanning number with the image data. The image data recording unit 106 records the correlated scanning number and the image data in the storage unit 109 as the data table T1 (ACT 12; storing image data).

The user sets the subsequent pages of the book (pages 2 and 3) in the image reading unit 101. The user presses the scanning execution button of the image forming apparatus 1.

The image reading unit 101 determines whether the first page for starting reading is set to the right page in the processing in ACT 1 (ACT 13).

When it is determined that the first page for starting reading is set to the right page (ACT 13; Yes), the image reading unit 101 scans the left page of the book in response to the scanning execution button being pressed by the user (ACT 14; scanning left page). In addition, magnification setting at this time is the same magnification setting as that in the first scanning. The image reading unit 101 outputs image data of the left page of the book which is scanned to the image data recording unit 106.

The image data recording unit 106 receives the image data from the image reading unit 101. The image data recording unit 106 correlates a scanning number with the image data. The image data recording unit 106 records the correlated scanning number and the image data in the storage unit 109 as the data table T1 (ACT 15; storing image data).

The image reading unit 101 outputs the image data of the left page of the book which is scanned to the image data recording unit 106. The image reading unit 101 determines whether the scanning is finished (ACT 16).

In addition, when it is determined that the first page for starting reading is not set to the right page (ACT 13; No), the image reading unit 101 determines whether to finish scanning of the book (ACT 16). At this time, the image reading unit 101 does not perform the processing in ACT 14. In addition, the image data recording unit 106 does not perform the processing in ACT 15.

The image reading unit 101 requests input from the user of whether to finish scanning of the book through the output unit 108 of the image forming apparatus 1. The user performs a user operation indicating to finish scanning the book. In this case, the image reading unit 101 determines to finish scanning of the book based on the user operation (ACT 16; Yes). When the image reading unit 101 determines to finish scanning of the book, the scanning process of the image forming apparatus 1 ends.

In addition, the user sets the subsequent pages (pages 4 and 5) of the book in the image reading unit 101. The user sets whether to scan both the left and right pages or only the right page of the book. The image reading setting unit 102 outputs scanning information to the image reading unit 101 according to the setting by the user. The scanning information indicates whether to scan both the left and right pages or only the right page of the book. The image reading unit 101 receives the scanning information from the image reading setting unit 102. When the scanning information is received, the image reading unit 101 determines that the scanning of the book is not finished (ACT 16; No). The image reading unit 101 sets scanning of both the left and right pages or scanning of only the right page of the book, based on the input scanning information (ACT 17; scanning setting).

Thereafter, the user presses the scanning execution button of the image forming apparatus 1.

The image reading unit 101 scans the right page of the book in response to the scanning execution button being pressed by the user (ACT 18; scanning of right page). The image reading unit 101 outputs the scanned image data of the right page of the book to the image data recording unit 106.

The image data recording unit 106 receives the image data from the image reading unit 101. The image data recording unit 106 correlates a scanning number with the image data. The image data recording unit 106 records the correlated scanning number and the image data in the storage unit 109 as the data table T1 (ACT 19; storing image data).

The image reading unit 101 outputs the scanned image data of the right page of the book to the image data recording unit 106. The image reading unit 101 determines whether only the right page of the book is to be scanned, based on the processing in ACT 17 (ACT 20).

When it is determined scanning only the right page of the book has not been set (ACT 20; No), the image reading unit 101 scans the left page of the book (scanning left page) (ACT 21). For example, when determining that scanning both the left and right pages of the book is set, the image reading unit 101 determines that scanning only for the right page of the book is not set. The image reading unit 101 outputs the scanned image data to the image data recording unit 106.

The image data recording unit 106 receives the image data from the image reading unit 101. The image data recording unit 106 correlates a scanning number with the image data. The image data recording unit 106 stores the correlated scanning number and the image data in the storage unit 109 as the data table T1 (ACT 22; storing image data). The image reading unit 101 outputs the scanned image data of the left page of the book to the image data recording unit 106. The image reading unit 101 determines whether the scanning processing in ACT 16 is finished.

A flow of operations for printing processing with the image forming apparatus 1, according to the embodiment illustrated in FIG. 8, is now described.

In the process in ACT 16, the user uses the image forming apparatus 1 to perform a user operation indicating that scanning of the book is finished.

In this case, the image reading unit 101 outputs a scanning ending signal to the page arranging unit 104 according to the user operation which finishes scanning of the book. The scanning ending signal denotes ending of scanning.

The page arranging unit 104 receives the scanning ending signal from the image reading unit 101. The page arranging unit 104 reads the data table T1 from the storage unit 109 based on the scanning ending signal. The page arranging unit 104 correlates the image data in each page with portions of the plurality of sheets so that the image data items in the data table T1 are in scanned order (ACT 21; determining printing position). For example, as illustrated in FIG. 4, when there are eight image data items, the page arranging unit 104 causes the eight image data items to be correlated with 8÷4=2 sheets. The page arranging unit 104 correlates the first image data with the right page on the outside of the first sheet. The page arranging unit 104 correlates the second image data with the right page on the inside of the first sheet. The page arranging unit 104 correlates the third image data with the right page on the outside of the second sheet. The page arranging unit 104 correlates the fourth image data with the right page on the inside of the second sheet. The page arranging unit 104 correlates the fifth image data with the left page on the inside of the second sheet. The page arranging unit 104 correlates the sixth image data with the left page on the outside of the second sheet. The page arranging unit 104 correlates the seventh image data with the left page on the inside of the first sheet. The page arranging unit 104 correlates the eighth image data with the left page on the outside of the first sheet.

The page arranging unit 104 stores correlation information denoting the correlated data and pages in the storage unit 109. The page arranging unit 104 outputs a correlation ending signal to the printing order determining unit 105. The correlation ending signal denotes ending of correlation processing.

The printing order determining unit 105 receives the correlation ending signal from the page arranging unit 104. The printing order determining unit 105 reads the correlation information from the storage unit 109 in response to the correlation ending signal. The printing order determining unit 105 determines printing order based on the correlation information and transport order using a duplex transporting function of the image forming apparatus 1 (ACT 22). For example, as illustrated in FIG. 5, in a case of the image forming apparatus 1 in which it is possible to input two sheets in advance onto the duplex transport path, the printing order determining unit 105 determines to print the outside of the second sheet firstly, as the rear surface. The printing order determining unit 105 determines to print the outside of the first sheet secondly as the rear surface. The printing order determining unit 105 determines to print the inside of the second sheet thirdly as the front surface. The printing order determining unit 105 determines to print the inside of the first sheet fourthly as the front surface.

The printing order determining unit 105 stores the printing order information in the storage unit 109. The printing order information denotes printing order. The printing order determining unit 105 outputs a printing order determining signal to the printing unit 107.

The printing unit 107 receives the printing order determining signal from the printing order determining unit 105. The printing unit 107 reads the printing order information and the image data from the storage unit 109. The printing unit 107 prints an image on a sheet based on the image data according to the printing order denoted by the printing order information (ACT 23).

When sheets are overlapped due to the duplex transporting function of the image forming apparatus 1, the binding unit binds a plurality of sheets in a bookbinding state (ACT 24). For example, the binding unit 103 performs saddle stitching in a finisher.

Hitherto, the printing process of the image forming apparatus 1 is described.

In this manner, the image forming apparatus 1 may perform binding so that pages after binding are in the same page order as that of a book, when each page of the book is scanned and bound.

In addition, the storage unit 109 according to the embodiment may be provided in any place in a range in which appropriate transceiving of information is performed. In addition, a plurality of storage units 109 may be provided in the range in which appropriate transceiving of information is performed. In addition, the storage unit 109 may store data that is received in the range in which appropriate transceiving of information is performed.

In addition, the order of the operations described above may be switched as appropriate.

According to the image forming apparatus 1 of at least one of the above described embodiments, it is possible to perform binding so that pages after binding are in the same page order as that of a book, when each page of the book is scanned and bound.

In addition, a computer system may be included in the above described image forming apparatus 1. In addition, instructions for the above described operations is stored in a computer-readable recording medium in a program format, and the above described operations are performed when a computer reads the program, and executes the instructions thereof. Here, as the computer readable recording medium, there are a magnetic disk, a magneto-optical disc, a CD-ROM, a DVD-ROM, a semiconductor memory, and the like. In addition, it may be a configuration in which the computer program is delivered to a computer using a wired or wireless communication line, and the computer to which the program is delivered executes the program.

In addition, the above described program may be a program for executing a part of the above described functions. In addition, the above described functions may be executed by combining the above described program with a program which is stored in the computer system in advance. That is, the above described program may be a so-called difference file (difference program).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus comprising:
a printer;
an image reader configured to scan and generate image data of a first page and a second page of an opened book; and
a processor configure to:
set a magnification so that an image size of the image data generated by the image reader becomes a size of a sheet among a plurality of sheets to be printed,
correlate the image data of each page with portions of the plurality of sheets to be printed, respectively, and
control the printer to print images corresponding to the image data on the respective correlated portions of the plurality of sheets so that the images corresponding to the image data are arranged on the portions of the plurality of sheets in a scanned order when the plurality of sheets are bound in a bookbinding state.

2. The apparatus according to claim 1, wherein the processor is further configured to determine a printing order with respect to printing surfaces of the plurality of sheets to be printed by the printing unit.

3. The apparatus according to claim 1, further comprising:
a binding unit configured to bind the plurality of sheets that have been printed into a bookbinding state.

4. The apparatus according to claim 3, wherein
the binding unit includes a finisher configured to saddle stitch the plurality of sheets that have been printed.

5. The apparatus according to claim 1, wherein the processor is further configured to:
add zero to three pages of dummy image data to image data which is scanned using the image reader so that a total number of pages of image data is 4N, where N is an integer greater than or equal to 2, and
correlate the image data of each page with the portions of the plurality of sheets as follows:
a first half of a front surface of an Mth sheet is a first portion,
a first half of a rear surface of the Mth sheet is a second portion,
a second half of the front surface of the Mth sheet is a third portion,
a second half of the rear surface of the Mth sheet is a fourth portion,
a (2M−1)th image data is correlated with the first portion of the Mth sheet,
a 2Mth image data is correlated with the second portion of the Mth sheet,
a (4N−2M−1)th image data is correlated with the third portion of the Mth sheet with respect to the N sheets,
a (4N−2M+2)th image data is correlated with a fourth portion of the Mth sheet,
with respect to the N sheets, a first portion of an (M+1)th sheet and the second portion of the Mth sheet face each other, and
with respect to the N sheets, a fourth portion of the (M+1)th sheet and the third portion of the Mth sheet confront each other,
wherein M is any integer from 1 to N−1.

6. The apparatus according to claim 5, wherein the processor is further configured to determine a printing order of duplex printing in order of a first to a Nth sheets having the portions that are correlated with image data items by the processor.

7. The apparatus according to claim 1, wherein the processor is further configured to set a start page for reading to one of first and second portion of a first sheet.

8. An image forming method comprising the steps of:
scanning and generating image data of a first page and a second page of an opened book using an image reader;
changing a magnification so that an image size of the image data generated by the image reader becomes a size of a sheet among a plurality of sheets to be printed;
correlating the image data of each page with portions of the plurality of sheets to be printed, respectively; and
printing images corresponding to the image data on the respective correlated portions of the plurality of sheets so that the images corresponding to the image data are printed on the portions of the plurality of sheets in a scanned order when the plurality of sheets are bound in a bookbinding state.

9. The method according to claim 8, further comprising the step of:
determining a printing order with respect to printing surfaces of the plurality of sheets to be printed by the printing unit.

10. The method according to claim 8, further comprising the step of:
binding the plurality of sheets that have been printed into a bookbinding state with a binding unit.

11. The method according to claim 10, wherein
the binding unit includes a finisher configured to saddle stitch the plurality of sheets that have been printed.

12. The method according to claim 8, further comprising:
adding zero to three pages of dummy image data to image data which is scanned using the image reader so that a total number of pages of image data is 4N, where N is an integer greater than or equal to 2; wherein
the image data of each page is correlated with the portions of the plurality of sheets as follows:
a first half of a front surface of an Mth sheet is a first portion,
a first half of a rear surface of the Mth sheet is a second portion,
a second half of the front surface of the Mth sheet is a third portion,
a second half of the rear surface of the Mth sheet is a fourth portion,
a (2M−1)th image data is correlated with the first portion of the Mth sheet,
a 2Mth image data is correlated with the second portion of the Mth sheet,
a (4N−2M+1)th image data is correlated with the third portion of the Mth sheet with respect to the N sheets,
a (4N−2M+2)th image data is correlated with a fourth portion of the Mth sheet,
with respect to the N sheets, a first portion of an (M+1)th sheet and the second portion of the Mth sheet face each other, and
with respect to the N sheets, a fourth portion of the (M+1)th sheet and the third portion of the Mth sheet confront each other,
wherein M is any integer from 1 to N−1.

13. The method according to claim 12, further comprising the step of:
determining a printing order of duplex printing in order of a first to a Nth sheets having the portions that are correlated with image data items.

14. The method according to claim 8, further comprising the step of:
setting a start page for reading to one of first and second portion of a first sheet.

15. A non-transitory computer readable medium containing instructions that cause an image forming apparatus to perform a method comprising the steps of:
scanning and generating image data of a first page and a second page of an opened book using an image reader;
changing a magnification so that an image size of the image data generated by the image reader becomes a size of a sheet among a plurality of sheets to be printed;
correlating the image data of each page with portions of the plurality of sheets to be printed, respectively; and
printing images corresponding to the image data on the respective correlated portions of the plurality of sheets so that the images corresponding to the image data are printed on the portions of the plurality of sheets in a scanned order when the plurality of sheets are bound in a bookbinding state.

16. The computer readable medium according to claim 15, the instructions causing the image forming apparatus to further perform the step of:
determining a printing order with respect to printing surfaces of the plurality of sheets to be printed by the printing unit.

17. The computer readable medium according to claim 15, the instructions causing the image forming apparatus to further perform the step of:
binding the plurality of sheets that have been printed into a bookbinding state with a binding unit.

18. The computer readable medium according to claim 15, the instructions causing the image forming apparatus to further perform the step of:
adding zero to three pages of dummy image data to image data which is scanned using the image reader so that a total number of pages of image data is 4N, where N is an integer greater than or equal to 2; wherein
the image data of each page is correlated with the portions of the plurality of sheets as follows:
a first half of a front surface of an Mth sheet is a first portion,
a first half of a rear surface of the Mth sheet is a second portion,
a second half of the front surface of the Mth sheet is a third portion,
a second half of the rear surface of the Mth sheet is a fourth portion,
a (2M−1)th image data is correlated with the first portion of the Mth sheet,
a 2Mth image data is correlated with the second portion of the Mth sheet,
a (4N−2M+1)th image data is correlated with the third portion of the Mth sheet with respect to the N sheets,
a (4N−2M+2)th image data is correlated with a fourth portion of the Mth sheet,
with respect to the N sheets, a first portion of an (M+1)th sheet and the second portion of the Mth sheet face each other, and
with respect to the N sheets, a fourth portion of the (M+1)th sheet and the third portion of the Mth sheet confront each other,
wherein M is any integer from 1 to N−1.

19. The computer readable medium according to claim 18, the instructions causing the image forming apparatus to further perform the step of:
determining a printing order of duplex printing in order of a first to a Nth sheets having the portions that are correlated with image data items.

20. The computer readable medium according to claim 15, the instructions causing the image forming apparatus to further perform the step of:
setting a start page for reading to one of first and second portion of a first sheet.
